(19) United States
(12) Patent Application Publication
(10) Pub. No.: US 2005/0252348 A1
(43) Pub. Date: Nov. 17, 2005

(54) Hand tool having adjustable assistant bar

(76) Inventor: Lin Yi Ting, Taichung (TW)

Correspondence Address: Lin Yi-Ting;No.22, Lane 146, Der-Fu Road, South Area, Taichung City, 3F-5, TW

(21) Appl. No.: 10/846,284

(22) Filed: May 17, 2004

(51) Int. Cl. B25B 23/16

(52) U.S. Cl. 81/177.5

(57) ABSTRACT

A hand tool includes a body having a function end such as a socket connection end of a screw driver end at a first end of the body and a first assistant bar movably extends through a through hole defined transversely through the body. The first assistant bar performs an arm of force when rotating the body and can be adjusted the length relative to the body. A second assistant bar is rotatably connected to a second end of the body so as to press the object to be tightened or loosened at the function end of the body.

### FIELD OF THE INVENTION

The present invention relates to a hand tool having two assistant bars connected to the tool in two different directions so that the user may efficiently operate the tool.

### BACKGROUND OF THE INVENTION

A conventional hand tool is disclosed in FIG. 1 and generally includes a first member 10 and a second member 11 which is orthogonal to the first member 10. A screw driver tip 110 is formed at a distal end of the first member 10 and a socket connection end 101 is connected to a distal end of the second member 11. Therefore, the user may use the tool to loosen/tighten a screw by the screw driver tip 110 or to loosen/tighten a nut or the like by connecting a socket with a recess 1011 in the socket connection end 101. However, the size of the recess 1011 and the shape of the screw driver tip 110 are fixed so that they can only be used to deal with specific type of screws and nuts. Although the two members 10 and 11 can be alternatively used as an arm of force when operating the tool, the length cannot be changed or adjusted when needed. Furthermore, when using the tool to tighten a nut for example, the socket connection end 101 or the socket connected to the socket connection end 101 often disengaged from the nut when rotating the first member 10. Therefore, the user has to re-engage the nut again and this consumes a lot of time. The conventional hand tool is in advantageous for storage and transportation because it occupies a large space.

The present invention intends to provide hand tool that includes a first assistant bar rotatably and longitudinally connected to the body of the tool and a second assistant bar movably and transversely connected to the body of the tool.

### SUMMARY OF THE INVENTION

The present invention relates to a hand tool that comprises a body having a function end at a first end of the body and a through hole is defined transversely through the body so that a first assistant bar movably extends through the through hole. A second assistant bar is rotatably connected to a second end of the body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional hand tool;

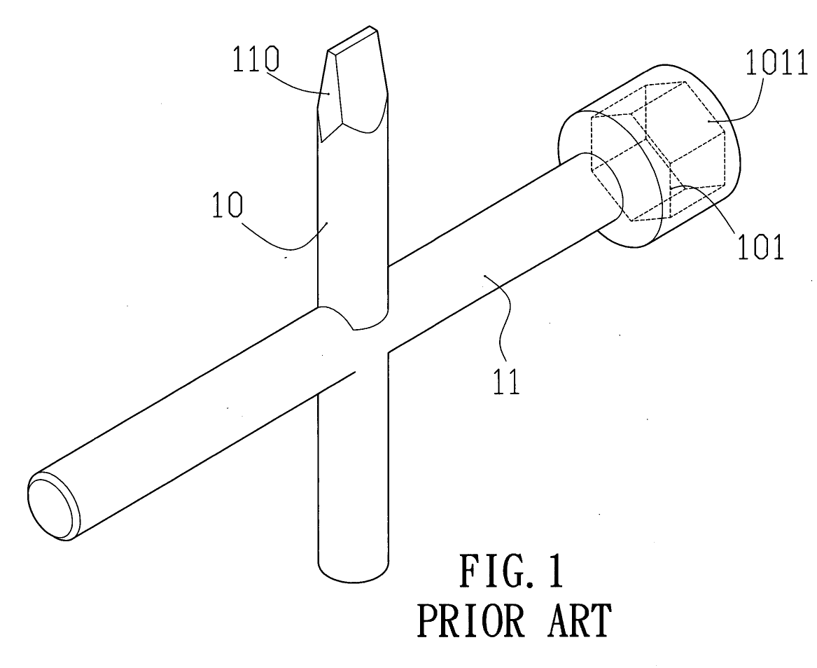

FIG. 2 is an exploded view to show a first embodiment of the hand tool of the present invention;

FIG. 3 is a cross sectional view of the hand tool of the present invention as shown in FIG. 2;

FIG. 4 is an exploded view to show a second embodiment of the hand tool of the present invention;

FIG. 5 is a cross sectional view of the hand tool of the present invention as shown in FIG. 4, and

FIG. 6 is a cross sectional view to show a third embodiment of the hand tool of the present invention.

### DETAILED DESCRIPTION OF THE PREFERRED EMBODIMENT

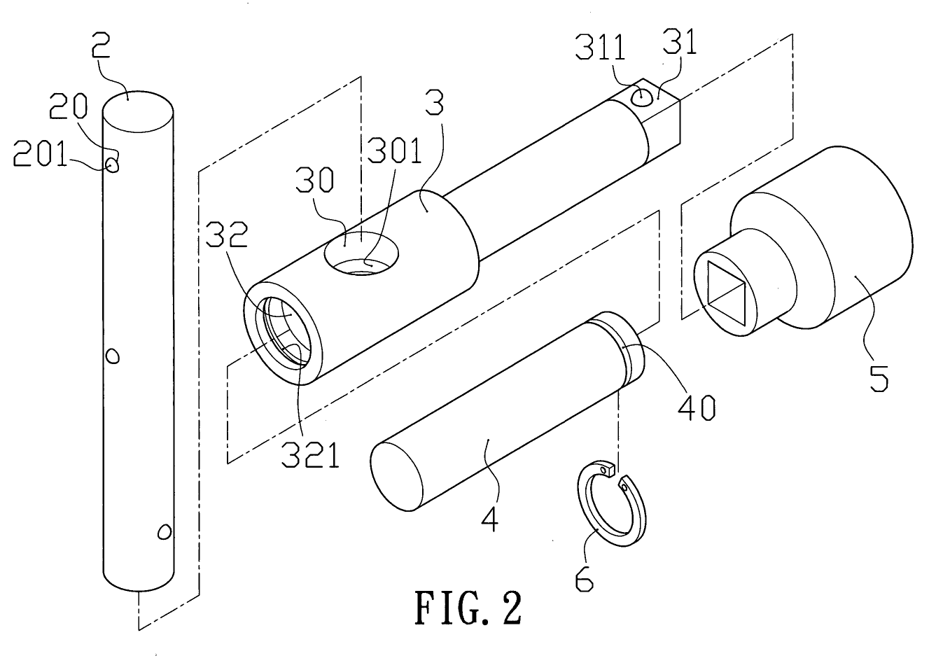

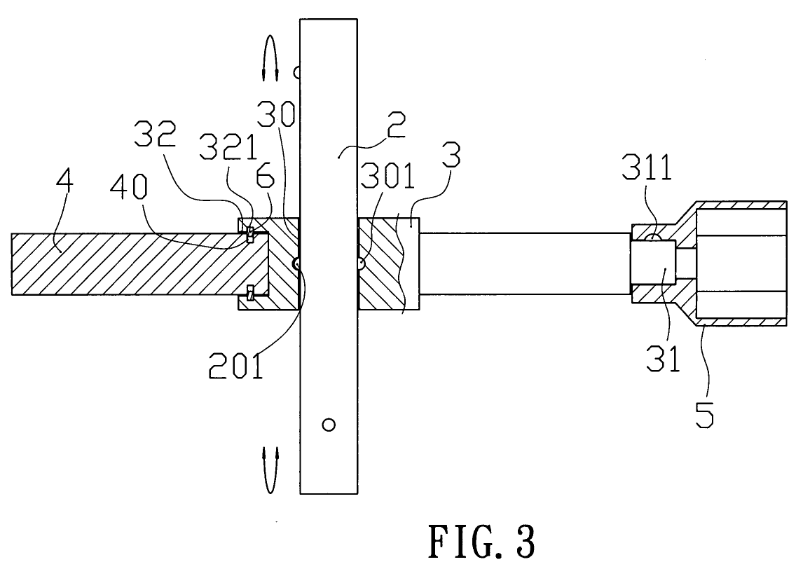

Referring to FIGS. 2 and 3, the hand tool of the present invention comprises a body 3 having a function end 31 at a first end of the body 3 and the function end 31 is a polygonal end and a positioning piece 311 extends from an outside of the function end 31. The function end 31 can be any known applications of hand tools, in this embodiment, a socket 5 can be connected to the function end 31. A through hole 30 is defined transversely through the body 3 and an inner periphery of the through hole 30 has at least one second positioning member 301 which is a recess in this embodiment.

A first assistant bar 2 movably extends through the through hole 30 and has a plurality of first positioning members 20 on an outer surface thereof. The first positioning members 20 in this embodiment are beads 201 extending from the outer surface of the first assistant bar 2. One of the first positioning members 20 is engaged with the second positioning member 301 so as to position the first assistant bar 2 to the body 3.

A second assistant bar 4 is co-axially and rotatably connected to a second end of the body 3. A receiving hole 32 is defined in the second end of the body 3 and an end of the second assistant bar 4 is rotatably inserted in the receiving hole 32. The second assistant bar 4 has a first groove 40 defined in an outer periphery thereof and a second groove 321 is defined in an inner periphery of the receiving hole 32. A C-shaped clamp 6 is engaged with the first and second grooves 40, 321. Therefore, the user may hold the second assistant bar 4 to press the body 3 against the object to be tightened or loosened, and the other hand rotates the first assistant bar 2 to rotate the body 3. When the object such as a nut mounted on a bolt is loose, the user conveniently rotates the first assistant bar 2 at a high speed while the nut is mounted by the socket 5. When the nut needs more torque to tighten, the first assistant bar 2 can be pulled longer so that a longer arm of force can be utilized.

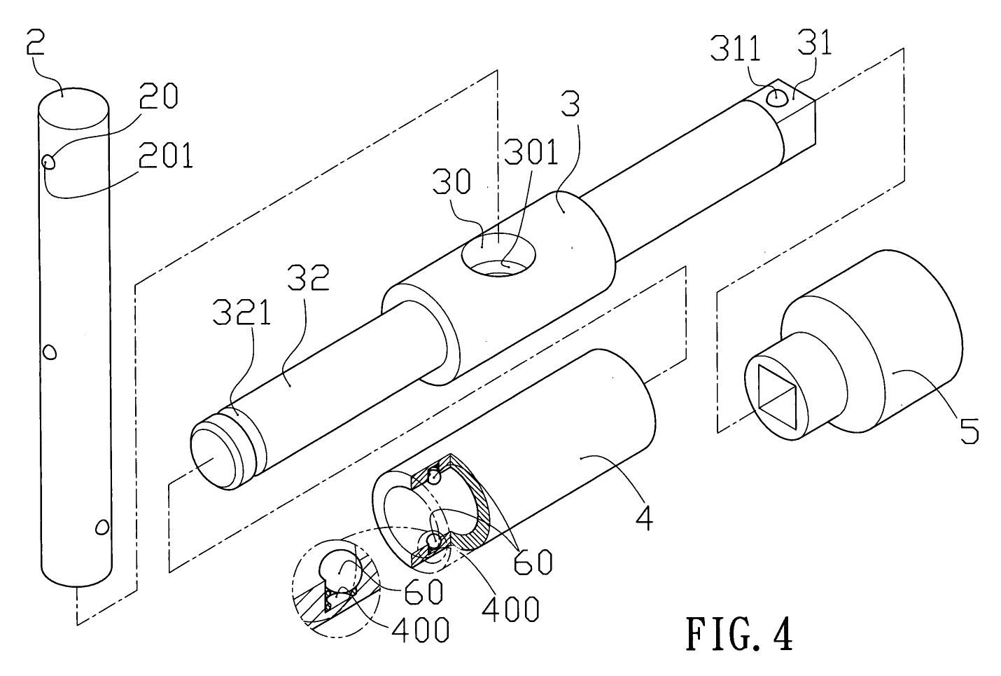

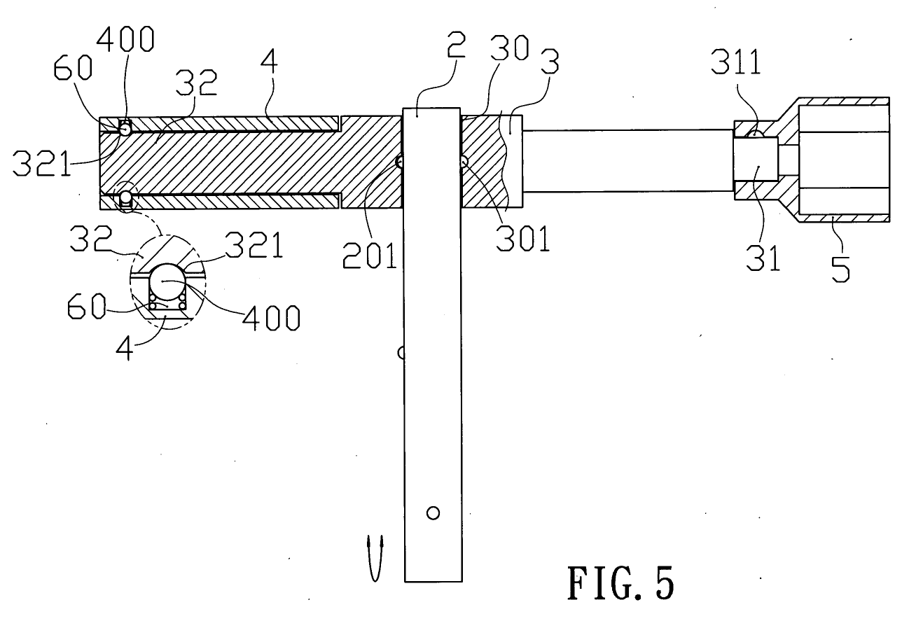

Referring to FIGS. 4 and 5, a second embodiment of the hand tool has a similar structure as the first embodiment in FIGS. 2 and 3, except for the connection of the second assistant bar 4 and the body 3. An extension bar 32 replaces the receiving hole 32 and extends from the second end of the body 3 and the second assistant bar 4 is rotatably mounted to the extension bar 32. The extension bar 32 includes a third groove 321 defmed in an outer periphery thereof and the second assistant bar 4 has two beads 60 engaged with two notches 400 defined in an inner periphery of the second assistant bar 4. The beads 60 are engaged with the third groove 321.

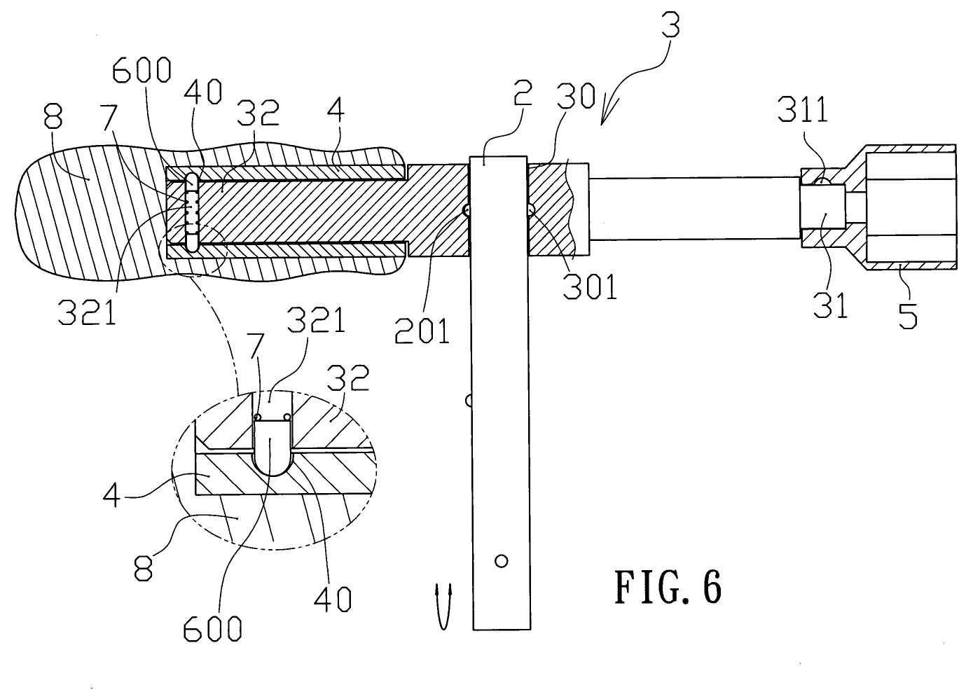

FIG. 6 shows a third embodiment of the hand tool wherein the extension bar 32 includes a passage 321 defined transversely therethrough and a spring 7 is received in the passage 321. Two positioning pieces 600 are respectively connected to two ends of the spring 7 and engaged with a fourth groove 40 defined in an inner periphery of the second assistant bar 4. A grip 8 is mounted to the second assistant bar 4 for convenience of grasp.

While we have shown and described the embodiment in accordance with the present invention, it should be clear to those skilled in the art that further embodiments may be made without departing from the scope of the present invention.

1. A hand tool comprising:
a body having a function end at a first end of the body and a through hole defined transversely through the body;
a first assistant bar movably extending through the through hole, and
a second assistant bar rotatably connected to a second end of the body.

2. The tool as claimed in claim 1, wherein the function end is a polygonal end and a positioning piece extending from an outside of the function end.

3. The tool as claimed in claim 1, wherein the first assistant bar has a plurality of first positioning members on an outer surface thereof and an inner periphery of the through hole has at least one second positioning member which is engaged with one of the first positioning members.

4. The tool as claimed in claim 3, wherein the first positioning members are beads extending from the outer surface of the first assistant bar and the at least one second positioning member is a recess.

5. The tool as claimed in claim 1, wherein the second assistant bar is co-axially connected to the body.

6. The tool as claimed in claim 1 further comprising a receiving hole is defined in the second end of the body and an end of the second assistant bar is rotatably inserted in the receiving hole.

7. The tool as claimed in claim 6, wherein the second assistant bar has a first groove defined in an outer periphery thereof and a second groove is defined in an inner periphery of the receiving hole, a C-shaped clamp engaged with the first and second grooves.

8. The tool as claimed in claim 1, wherein an extension bar extends from the second end of the body and the second assistant bar is rotatably mounted to the extension bar.

9. The tool as claimed in claim 8, wherein the extension bar includes a third groove defined in an outer periphery thereof and the second assistant bar has two beads engaged with two notches defined in an inner periphery of the second assistant bar, the beads engaged with the third groove.

10. The tool as claimed in claim 8, wherein the extension bar includes a passage defined transversely therethrough and a spring is received in the passage, two positioning pieces respectively connected to two ends of the spring and engaged with a fourth groove defined in an inner periphery of the second assistant bar.
